(19) United States
(12) Patent Application Publication
(10) Pub. No.: US 2011/0273785 A1
(43) Pub. Date: Nov. 10, 2011

(54) LENS BARREL

(75) Inventor: Yasuhiro Hatakeyama, Saitama (JP)

(73) Assignee: TAMRON CO., LTD.

(21) Appl. No.: 13/036,486

(22) Filed: Feb. 28, 2011

(30) Foreign Application Priority Data
May 7, 2010 (JP) 2010-107746

(51) Int. Cl. G02B 7/02

(52) U.S. Cl. 359/739; 359/825

(57) ABSTRACT

A first tilt unit that is to abut a first tilt receiving unit of a rotating member is provided at a peripheral portion of a first lens frame. A second lens frame moves in a direction parallel to the optical axis, integrally with an adjustable diaphragm by a protrusion passing through a coil-shaped optical-axis biased spring and a hole provided in a base member. On a side surface of a linear-guidance ring, a guide groove is formed to engage with a lug of the second lens frame and slide the second lens frame in a direction parallel to the optical axis in the linear-guidance ring. Further, on an inner surface of the linear-guidance ring, a second tilt unit that is to abut a second tilt receiving unit of the rotating member is provided.

### BACKGROUND OF THE INVENTION

1. Field of the Invention

The present invention relates to a lens barrel equipped with an adjustable diaphragm mechanism.

2. Description of the Related Art

Amidst recent demands for high zoom power and brightness, with fixed-diaphragm retractable lenses, it has become difficult to maintain a balance between resolution and brightness at the wide angle edge and the telephoto edge. For example, if the brightness is set based on capturing images at the wide angle edge, light becomes insufficient at the telephoto edge, reducing resolution. Meanwhile, if the brightness is set based on capturing images at the telephoto edge, light becomes excessive at the wide angle edge, reducing resolution.

To address such problems, variation of the aperture according to focal length, from the wide angle edge to the telephoto edge, is necessary. Typically, to vary the aperture, a scheme of using an actuator, such as a stepping motor, to control an adjustable diaphragm is adopted. However, with such schemes, there is a limit to the extent that intervals between lenses can be reduced since the adjustable diaphragm is disposed therebetween, whereby size reductions are hindered, particularly, in a dimension parallel to the optical axis of the lens barrel. Therefore, techniques have been posed to achieve size reductions, such as those disclosed in Japanese Patent No. 3676518, Japanese Patent No. 4128895, Japanese Patent Application Laid-Open Publication No. 2009-122712, Japanese Patent Application Laid-Open Publication No. 2008-40161, Japanese Patent Application Laid-Open Publication No. 2006-98701, Japanese Patent Application Laid-Open Publication No. 2006-39373, and Japanese Patent Application Laid-Open Publication No. 2004-252367. For example, when the lens barrel is in a retracted state, a portion of a lens is pushed into the aperture of the diaphragm, enabling the interval between the lenses to be reduced irrespective of the disposal of the diaphragm and realizing a reduction in the dimension parallel to the optical axis of the lens barrel.

For example, with the technique recited in Japanese Patent No. 3676518, when the camera is in use, blades of an adjustable diaphragm are closed, fulfilling the role of a diaphragm. On the other hand, when the lens barrel is retracted, the blades of the adjustable diaphragm are open and the convex surface of a convex lens is caused to be housed in the aperture of the adjustable diaphragm by a lens drive mechanism, whereby a reduction in the dimension parallel the optical axis of the lens barrel is realized. However, an independent actuator that coordinates the opening and closing of the adjustable diaphragm is required and consequently problems remain, i.e., space is required to dispose the actuator and the problem of increased components becomes unavoidable.

With the technique recited in Japanese Patent No. 4128895, when the camera is in use, blades of an adjustable diaphragm are shut, fulfilling the role of a diaphragm. On the other hand, when the lens barrel is retracted, a lens drive mechanism, via a rod-shaped member provided on a lens frame holding a convex lens disposed on the imaging side of the diaphragm blades, causes the convex lens to reside at the opening of the diaphragm blades, where the convex surface of the convex lens is housed in the aperture of the diaphragm blades. Thus, during the retracted state of the lens barrel, a size reduction parallel the optical axis of the lens apparatus can be realized. Further, as there is no need for newly equipping an actuator to control the opening and closing of the diaphragm, there is an advantage of achieving a lens barrel configured by fewer components. However, a problem remains in that when the camera is in use, gradual changes in the diameter of the adjustable diaphragm cannot be performed by the lens drive mechanism.

Furthermore, with the techniques recited in Japanese Patent Application Laid-Open Publication No. 2009-122712, Japanese Patent Application Laid-Open Publication No. 2008-40161, Japanese Patent Application Laid-Open Publication No. 2006-98701, Japanese Patent Application Laid-Open Publication No. 2006-39373, and Japanese Patent Application Laid-Open Publication No. 2004-252367, a problem remains in that even if a reduction in the dimension parallel to the optical axis of the lens barrel is achieved, component reduction is insufficient, or the size reduction of the lens barrel is insufficient due to the disposal of an actuator being necessary to drive the adjustable diaphragm.

### SUMMARY OF THE INVENTION

It is an object of the present invention to at least solve the above problems in the conventional technologies.

A lens barrel according to one aspect of the invention includes, sequentially from an object side a first lens frame holding a first lens group; an adjustable diaphragm including a rotating member that is capable of rotating about an optical axis, with respect to a base member, an elastic member that biases the rotating member in a direction following a perimeter of the base member, centered about the optical axis, and diaphragm blades that open and close via rotation of the rotating member; a second lens frame that moves in a direction parallel to the optical axis, integrally with the adjustable diaphragm and holds a second lens group having at least a convex surface facing toward the object side; a linear-guidance ring that guides the first lens frame and the second lens frame in a direction parallel to the optical axis; a lens drive mechanism that supplies a driving force to move the first lens frame and the second lens frame in a direction parallel to the optical axis; a first opening/closing mechanism that moves the diaphragm blades between a partially open position and an open position (maximum diaphragm diameter) via the driving force of the lens drive mechanism, if the first lens frame and the second lens frame are separate by a given distance or less; and a second opening/closing mechanism that moves the diaphragm blades between a closed position (minimum diaphragm diameter) and the partially open position via the drive force of the lens drive mechanism, if the first lens frame and the second lens frame are separated by the given distance or more. The adjustable diaphragm is pushed by the first lens frame and moves relatively toward the second lens frame, whereby at least a portion of the convex surface of the second lens group is inserted into an aperture of the diaphragm blades, if the first lens frame and the second lens frame are separated by a second given distance or less.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a perspective view depicting one configuration example of an adjustable diaphragm included in a lens barrel according to the invention;

FIGS. 2 and 3 are exploded perspective views depicting a configuration of the lens barrel according to the invention;

FIG. 4 is a partial cross-sectional view of the lens barrel;

FIGS. 5 and 6 depict the state of the lens barrel at the telephoto edge;

FIG. 7 depicts the state of the aperture of the adjustable diaphragm at a telephoto edge as viewed from the object side;

FIG. 8 depicts the state of the lens barrel at a mid-position;

FIG. 9 depicts the state of the aperture of the adjustable diaphragm at the mid-position as viewed from the object side;

FIG. 10 depicts the state of the lens barrel at a wide angle edge;

FIGS. 11 and 12 depict the state lens barrel when the lens barrel is retracted; and

FIG. 13 depicts the state of the aperture of the adjustable diaphragm when the lens barrel is retracted, as viewed from the object side.

### DETAILED DESCRIPTION OF THE PREFERRED EMBODIMENTS

Referring to the accompanying drawings, exemplary embodiments according to the present invention are explained in detail below.

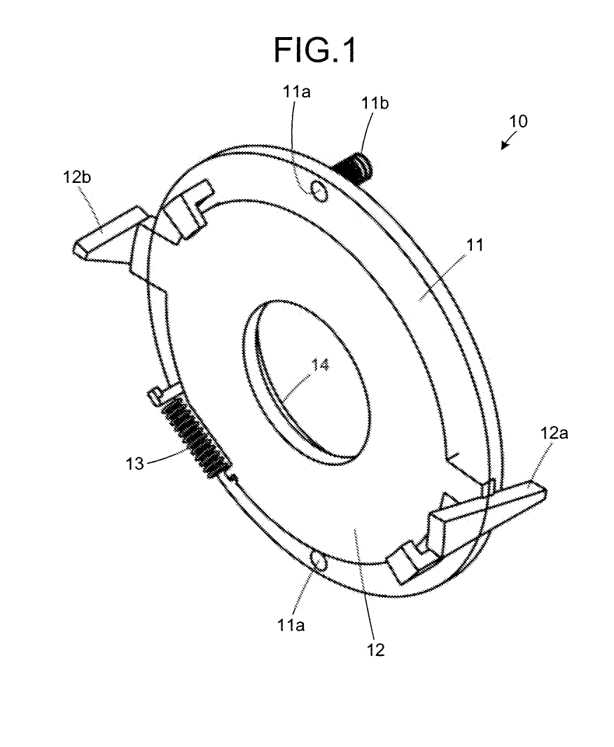

FIG. 1 is a perspective view depicting one configuration example of an adjustable diaphragm included in a lens barrel according to the invention. This adjustable diaphragm 10 includes a base member 11, a rotating member 12, a spring (elastic member) 13, and diaphragm blades 14. At a peripheral portion of the base member 11, an opening 11a is formed into which a protrusion provided on a second lens frame described hereinafter is inserted. On the image side of the opening 11a, an optical-axis biased spring 11b having a coil shape is disposed. The optical-axis biased spring 11b is for recovery of the adjustable diaphragm 10 from a state of being pushed into the second lens frame. The rotating member 12 can rotate about the optical axis, with respect to the base member 11; the spring 13 biases the rotating member 12 in a direction following the perimeter of the base member 11, centered about the optical axis. When the rotating member 12 rotates counterclockwise with respect to the base member 11, the diaphragm blades 14 open and when the rotating member 12 rotates clockwise, the diaphragm blades 14 closes. When no force is applied to the rotating member 12, the rotating member 12 is biased in a clockwise direction by the spring. At a peripheral portion of the rotating member 12, a second tilt receiving unit 12a that abuts a second tilt unit provided on an inner side of a linear-guidance ring described hereinafter, is disposed. The second tilt receiving unit 12a gradually becomes smaller toward the imaging side and has an acuate end. At a peripheral portion of the rotating member 12, a first tilt receiving unit 12b that abuts a first tilt unit of a first lens frame described hereinafter is disposed. The first tilt receiving unit 12b gradually becomes smaller toward the object side and has an acuate end. The first tilt receiving unit 12b and the second tilt receiving unit 12a are disposed on the rotating member 12 at positions symmetrical about the optical axis.

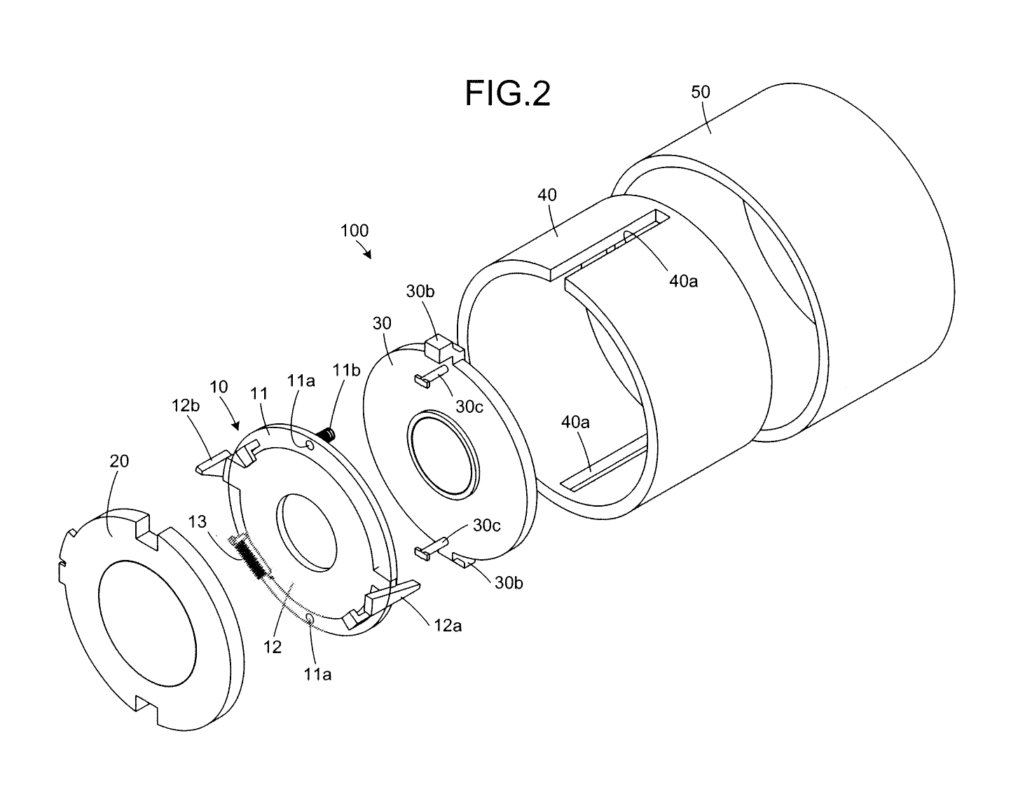

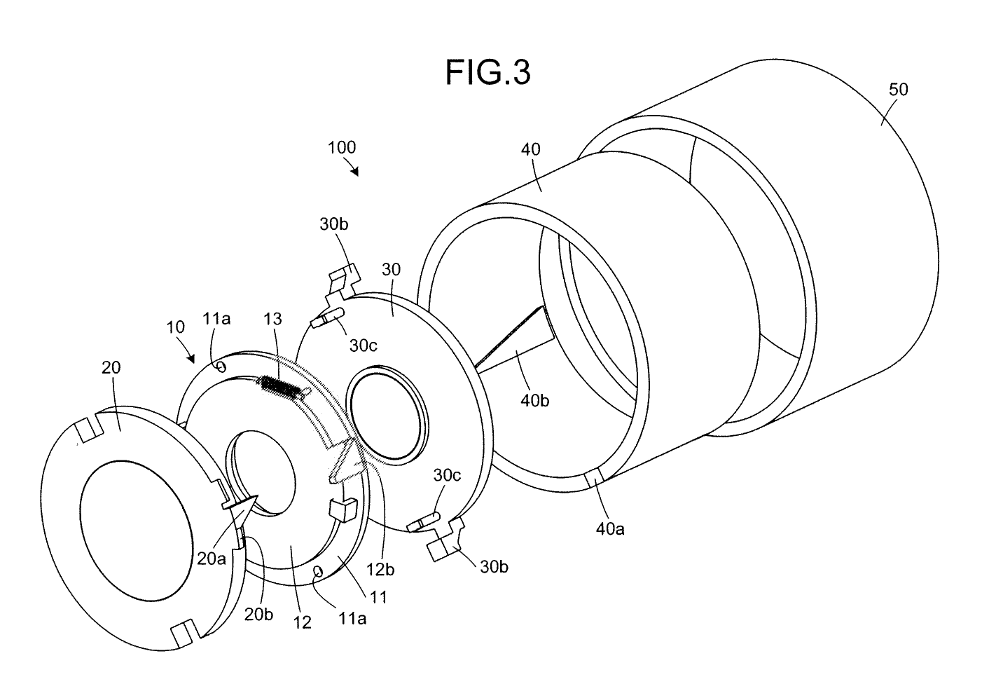

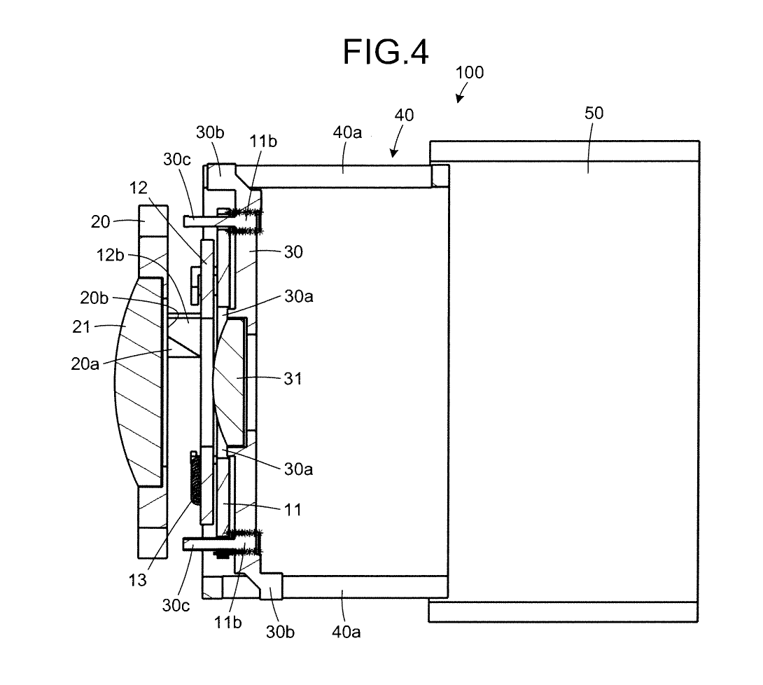

FIGS. 2 and 3 are exploded perspective views depicting a configuration of the lens barrel according to the invention. FIG. 3 depicts the state depicted in FIG. 2 rotated approximately 180 degrees about the optical axis. FIG. 4 is a partial cross-sectional view of the lens barrel. This lens barrel 100 includes sequentially from the side (object side) to be pointed toward a non-depicted object, a first lens frame 20, an adjustable diaphragm 10, and a second lens frame 30, which are accommodated in a linear-guidance ring 40. The linear-guidance ring 40 is further accommodated in a barrel 50. Movement of the first lens frame 20 and the second lens frame 30 with respect to the linear-guidance ring 40 and accommodation of the linear-guidance ring 40 in the barrel 50 is performed through the operation of a non-depicted lens drive mechanism.

The first lens frame 20 holds a first lens group 21 and at an outer peripheral portion, a first tilt unit 20a is provided that abuts the first tilt receiving unit 12b of the rotating member 12. The first tilt unit 20a gradually becomes smaller toward the image side of the lens barrel 100 and has an acuate end. Therefore, when the first lens frame 20 and the second lens frame 30 become closer than a given distance (the distance between the first lens frame 20 and the second lens frame 30, when the first tilt unit 20a and the first tilt receiving unit 12b abut), engagement of the first tilt unit 20a and the first tilt receiving unit 12b gradually progresses, whereby the rotating member 12 gradually rotates counter-clockwise about the optical axis, with respect to the base member 11, and the diaphragm blades 14 move from a partially open position to an open position (maximum diaphragm diameter). Thus, the first tilt unit 20a and the first tilt receiving unit 12b configure a first opening/closing mechanism that controls the operation of opening and closing the aperture of the adjustable diaphragm 10 between the partially open position and the open position (maximum diaphragm diameter). The end of the first tilt receiving unit 12b abuts the first tilt unit 20a near the base thereof, where a stopper 20b is provided to properly maintain a minimum interval between the first lens group 21 and the adjustable diaphragm 10. When the first tilt receiving unit 12b and the stopper 20b abut, the aperture of the adjustable diaphragm 10 is at the maximum diaphragm diameter.

The second lens frame 30 holds a second lens group 31. The second lens group 31 includes a mask diaphragm 30a prescribing a given aperture. The effective diameter of the mask diaphragm 30a is smaller than the open position (maximum diaphragm diameter) of the adjustable diaphragm 10. Further, at a peripheral portion of the second lens frame 30, a lug 30b is provided that fits with a guide groove (described hereinafter) provided in the linear-guidance ring 40. On a surface on the object side of the second lens frame 30, a protrusion 30c is provided. The protrusion 30c passes through the coil-shaped optical-axis biased spring 11b and the opening 11a formed in the base member 11, whereby the second lens frame 30 can be moved in a direction parallel to the optical axis, integrally with the adjustable diaphragm 10. When the first tilt receiving unit 12b and the stopper 20b abut, the interval between the first lens group 21 and the adjustable diaphragm 10 becomes fixed. As the first lens group 21 and the second lens group 31 approach one another, the adjustable diaphragm 10 is pushed by the first lens frame 20, whereby the adjustable diaphragm 10 resists the bias of the optical-axis biased spring 11b and moves relatively toward the second lens frame 30 (described hereinafter).

Along a side surface of the linear-guidance ring 40, the guide groove 40a is provided that engages with the lug 30b of the second lens frame 30 and slides the second lens frame 30 along a direction parallel to the optical axis in the linear-guidance ring 40. On an inner surface of the linear-guidance ring 40, a second tilt unit 40b is provided that abuts the second tilt receiving unit 12a of the rotating member 12. The second tilt unit 40b gradually becomes smaller toward the object side and has an acuate end. Further, the second tilt unit 40b is longer than the second tilt receiving unit 12a. When the first lens frame 20 and the second lens frame 30 are separated by more than a given distance (the distance between the first lens frame 20 and the second lens frame 30, when the first tilt unit 20a and the first tilt receiving unit 12b abut), engagement of the second tilt unit 40b and the second tilt receiving unit 12a gradually progresses, whereby the rotating member 12 gradually rotates clockwise about the optical axis, with respect to the base member 11, and the diaphragm blades 14 move from the partially open position to a closed position (minimum diaphragm diameter). Thus, the second tilt unit 40b and the second tilt receiving unit 12a configure a second opening/closing mechanism that controls the operation of gradually opening and closing the aperture of the adjustable diaphragm 10 between the partially open position and the closed position (minimum diaphragm diameter).

A first angle formed by the first tilt unit 20a (or the first tilt receiving unit 12b) and the optical axis is greater than a second angle formed by the second tilt unit 40b (or the second tilt receiving unit 12a) and the optical axis.

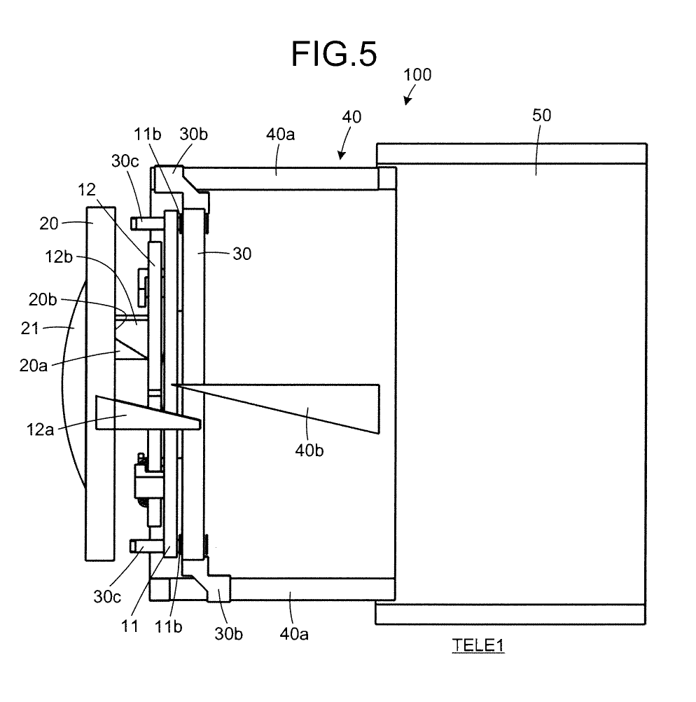

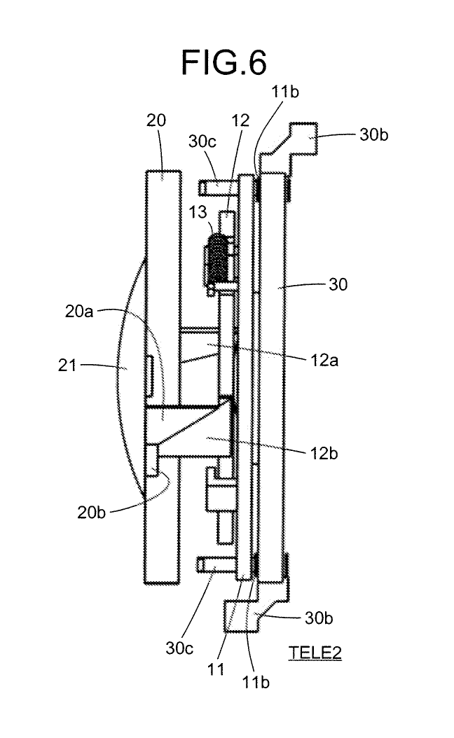

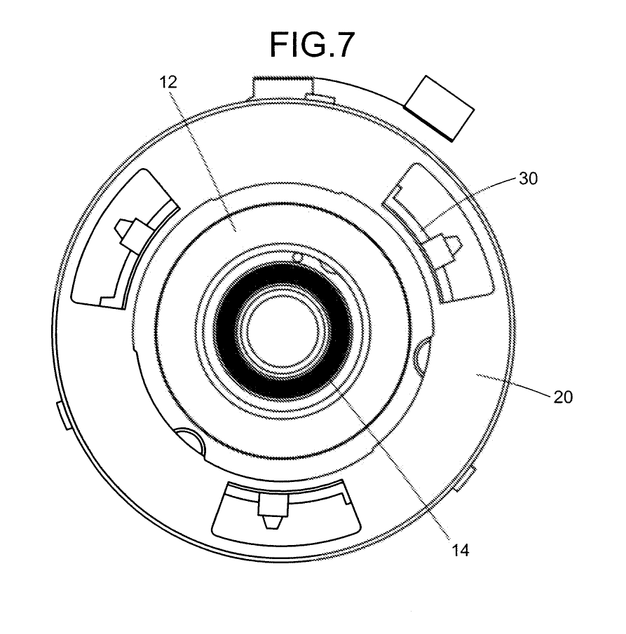

Next, operation of the lens barrel will be described. FIGS. 5 and 6 depict the state of the lens barrel at the telephoto edge. FIG. 7 depicts the state of the aperture of the adjustable diaphragm at the telephoto edge as viewed from the object side. FIG. 6 depicts the state depicted in FIG. 5 rotated approximately 180 degrees about the optical axis.

The telephoto edge is a state in which the second lens frame 30 and the adjustable diaphragm 10 have moved integrally to the shallowest portion of the linear-guidance ring 40 (side farthest on object side). In the process of the second lens frame 30 and the adjustable diaphragm 10 moving along the inner surface of the linear-guidance ring 40 toward the object side (left-hand side in drawing), when the first lens frame 20 and the second lens frame 30 become closer than the given distance (the distance between the first lens frame 20 and the second lens frame 30, when the first tilt unit 20a and the first tilt receiving unit 12b abut), engagement of the first tilt unit 20a and the first tilt receiving unit 12b gradually progresses, whereby the rotating member 12 gradually rotates counter-clockwise about the optical axis, with respect to the base member 11, and the diaphragm blades 14 move from the partially open position to the open position (maximum diaphragm diameter) (refer to FIG. 7). When the first lens frame 20 and the second lens frame 30 become separated by a second given distance (a distance slightly shorter than the distance separating the first lens frame 20 and the second lens frame 30, when the stopper 20b and the first tilt receiving unit 12b abut) or less, the adjustable diaphragm 10 is pushed by the first lens frame 20 and moves relatively toward the second lens frame 30, whereby at least a portion of a convex surface of the second lens group 31 is inserted into the aperture of the diaphragm blades 14. When the first lens frame 20 and the second lens frame 30 become separated by a third given distance (a distance slightly shorter than the second given distance) or less, the adjustable diaphragm 10 is pushed by the first lens frame 20 and moves farther toward the second lens frame 30 and the convex surface of the second lens group 31 becomes entirely inserted into the aperture of the diaphragm blades 14. When the first lens frame 20 and the second lens frame 30 become separated by the given distance or less, the first tilt unit 20a and the first tilt receiving unit 12b abut and slide while at the same time the second tilt unit 40b and the second tilt receiving unit 12a move away from one another. Consequently, the first opening/closing mechanism configured by the first tilt unit 20a and the first tilt receiving unit 12b and the second opening/closing mechanism configured by the second tilt unit 40b and the second tilt receiving unit 12a do not interfere with one another when driven.

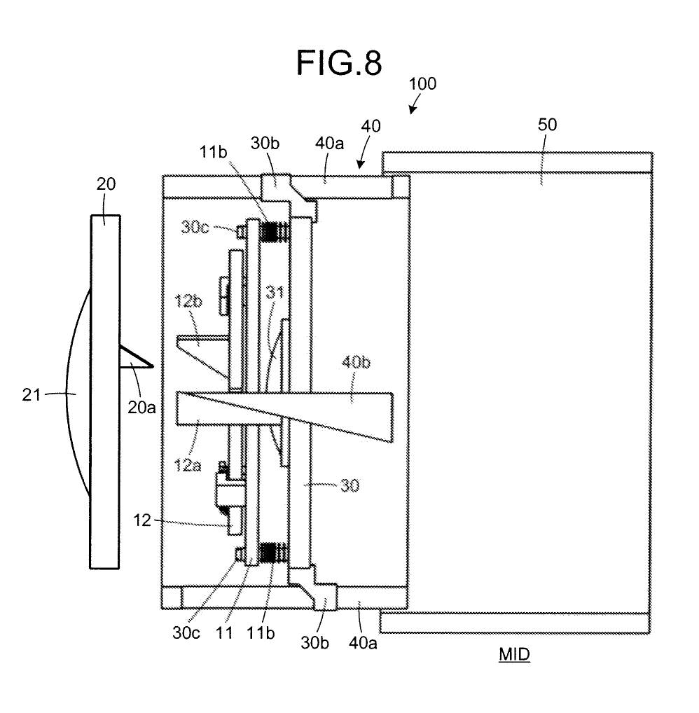

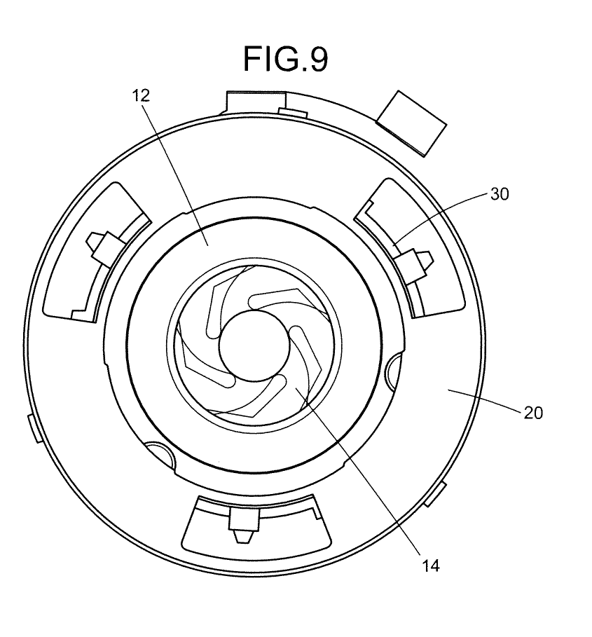

FIG. 8 depicts the state of the lens barrel at a mid-position. FIG. 9 depicts the state of the aperture of the adjustable diaphragm at a mid-position as viewed from the object side. The mask diaphragm 30a has an effective diameter formed to be greater than the aperture of the adjustable diaphragm 10. A mid-position is a state in which the second lens frame 30 and the adjustable diaphragm 10 have moved integrally to a mid-portion of the linear-guidance ring 40. As the second lens frame 30 and the adjustable diaphragm 10 integrally move from the object side gradually to the image side (right-hand side in drawing), the first tilt unit 20a and the first tilt receiving unit 12b move away from one another and, the second tilt unit 40b and the second tilt receiving unit 12a abut and slide. During this process, the rotating member 12 gradually rotates clockwise about the optical axis, with respect to the base member 11 and the diaphragm blades 14 gradually move from the partially open position to the closed position (minimum diaphragm diameter) (refer to FIG. 9). At this time, the adjustable diaphragm 10 is relieved from the pushing force of the first lens frame 20 and, by the action of the optical-axis biased spring 11b, moves more toward the first lens frame 20 relative to the telephoto edge state. Further, the convex surface of the second lens group 31 is removed from the aperture of the diaphragm blades 14.

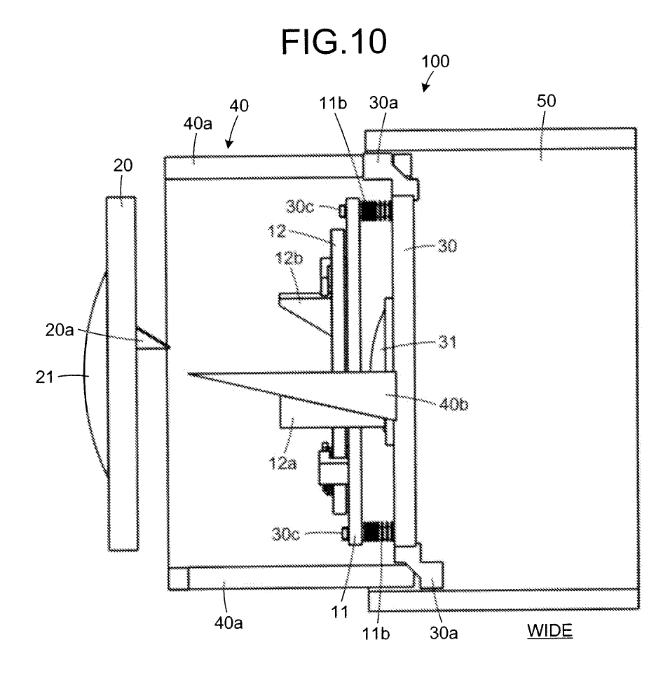

FIG. 10 depicts the state of the lens barrel at the wide angle edge. The aperture of the adjustable diaphragm at wide angle edge is smaller than that depicted in FIG. 9. The wide angle edge is a state in which the second lens frame 30 and the adjustable diaphragm 10 have moved integrally toward the deepest position of the linear-guidance ring 40 (side farthest on image side). From the state depicted in FIG. 8, the second lens frame 30 and the adjustable diaphragm 10 integrally move toward the image side (left-hand side in drawing) of the linear-guidance ring 40, whereby the second tilt receiving unit 12a provided on the rotating member 12 and the second tilt unit 40b provided on the linear-guidance ring 40 abut at a deeper position. During this process, the rotating member 12 further rotates clockwise about the optical axis, with respect to the base member 11. The aperture diameter of the adjustable diaphragm 10 becomes even smaller than the state depicted in FIG. 9.

As described, the lens barrel 100, without using a driving unit for the adjustable diaphragm, such as an actuator, enables the opening and closing of the adjustable diaphragm 10 and gradual variation of the aperture diameter. The provision of a driving unit for the adjustable diaphragm, such as an actuator, invites increased size of the lens barrel and increases the number of components in and the complexity of the configuration. Therefore, the lens barrel 100, which does not incorporate a driving unit for the adjustable diaphragm, is suitable as a lens barrel for which a compact size, a simple configuration, and fewer components are desirable. The lens barrel 100 facilitates further size reduction of a dimension parallel to the optical axis since the convex surface of the second lens group 31 is inserted into the aperture of the adjustable diaphragm 10, during the telephoto edge state.

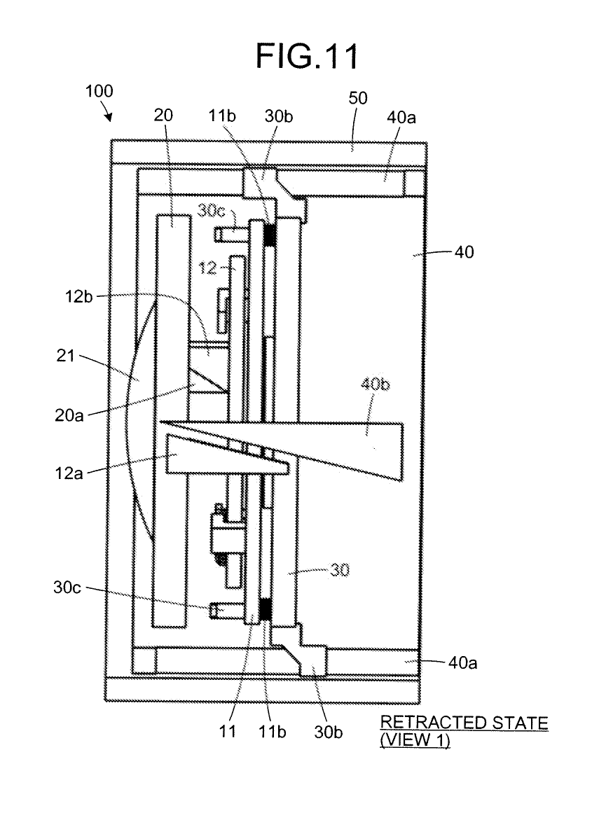

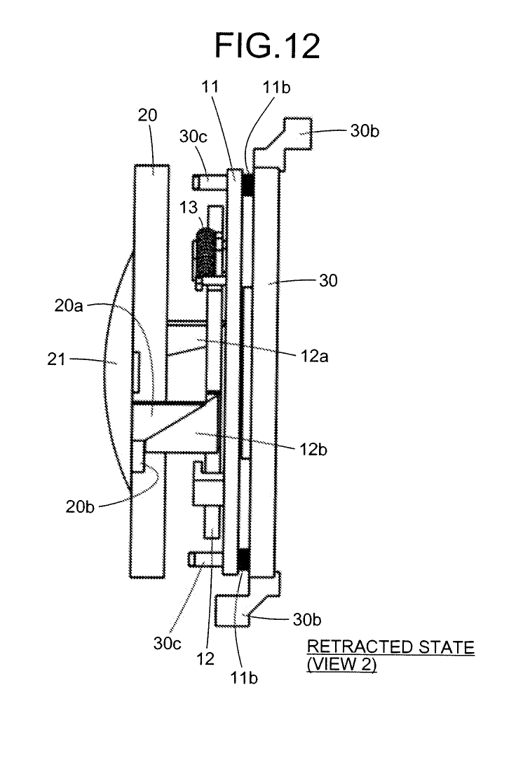

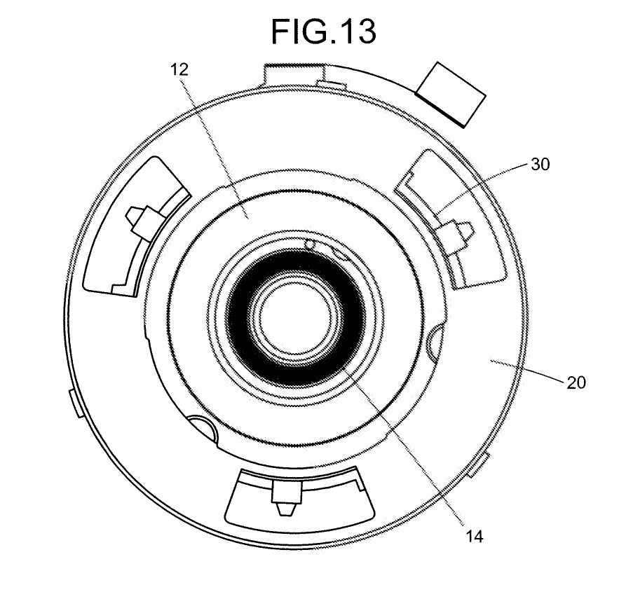

The state when the lens barrel is retracted will be described. FIGS. 11 and 12 depict the state lens barrel when the lens barrel is retracted. FIG. 13 depicts the state of the aperture of the adjustable diaphragm when the lens barrel is retracted, as viewed from the object side. FIG. 12 depicts the state depicted in FIG. 11 rotated approximately 180 degrees about the optical axis.

As depicted in FIG. 12, when the lens barrel 100 is retracted, the relative positions of the first lens frame 20, the adjustable diaphragm 10, and the second lens frame 30 is identical to that during the telephoto state described above. In other words, by the first lens frame 20 and the second lens frame 30 being separated by the third given distance (a distance slightly shorter than the second given distance) or less, the adjustable diaphragm 10 is pushed by the first lens frame 20 and moves relatively toward the second lens frame 30 and, the convex surface of the second lens group 31 is entirely inserted into the aperture of the diaphragm blades 14. As described, with the lens barrel 100, when the first lens frame 20 and second lens frame 30 are separated by the given distance or less, the first tilt unit 20a and the first tilt receiving unit 12b abut and slide, and at the same time, the second tilt unit 40b and the second tilt receiving unit 12a move away from one another. As depicted in FIG. 11, with the second tilt unit 40b and the second tilt receiving unit 12a away from one another, the first lens frame 20, the adjustable diaphragm 10, and the second lens frame 30 are housed in the linear-guidance ring 40, which can be further housed in the barrel 50.

Such configuration is possible because, as described, the first tilt receiving unit 12b and the second tilt receiving unit 12a are disposed on the rotating member 12 at positions symmetrical about the optical axis and the first angle formed by the first tilt unit 20a (or the first tilt receiving unit 12b) and the optical axis is greater than the second angle formed by the second tilt unit 40b (or the second tilt receiving unit 12a) and the optical axis, whereby even if the first lens frame 20 and the rotating member 12 are as close as the third given distance, a non-interfering positional relationship between the second tilt unit 40b and the second tilt receiving unit 12a can be formed.

As described, the lens barrel 100 facilitates further reduction of the dimension parallel to the optical axis since the lens barrel 100 can be retracted with the convex surface of the second lens group 31 inserted into the aperture of the adjustable diaphragm 10.

As described, according to the present invention, without use of a driving unit for the adjustable diaphragm, such as an actuator, the opening and closing of the adjustable diaphragm and gradual variation of the aperture can be performed as well as reductions in the size of the lens barrel, simplification of the configuration, and a reduction in the number of components. Further, when the lens barrel is in a retracted state or telephoto state, the convex surface of the second lens group is inserted into the aperture of the adjustable diaphragm, further enabling reduction of a dimension parallel to the optical axis of the lens barrel.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

### CROSS-REFERENCE TO RELATED APPLICATIONS

This application is based upon and claims the benefit of priority from the prior Japanese Patent Application No. 2010-107746, filed on May 7, 2010, the entire contents of which are incorporated herein by reference.

What is claimed is:

1. A lens barrel comprising, sequentially from an object side:
a first lens frame holding a first lens group;
an adjustable diaphragm including
a rotating member that is capable of rotating about an optical axis, with respect to a base member,
an elastic member that biases the rotating member in a direction of a circumference centered about the optical axis, with respect to the base member, and
diaphragm blades that open and close consequent to rotation of the rotating member;
a second lens frame that moves in a direction parallel to the optical axis, integrally with the adjustable diaphragm and holds a second lens group having at least a convex surface facing toward the object side;
a linear-guidance ring that guides the first lens frame and the second lens frame in a direction parallel to the optical axis;
a lens drive mechanism that supplies a driving force to move the first lens frame and the second lens frame in a direction parallel to the optical axis;
a first opening/closing mechanism that moves the diaphragm blades between a partially open position and an open position (maximum diaphragm diameter) consequent to the driving force of the lens drive mechanism, if the first lens frame and the second lens frame are separated by a given distance or less;
a second opening/closing mechanism that moves the diaphragm blades between a closed position (minimum diaphragm diameter) and the partially open position consequent to the drive force of the lens drive mechanism, if the first lens frame and the second lens frame are separated by the given distance or more, wherein
the adjustable diaphragm is pushed by the first lens frame and moves relatively toward the second lens frame, whereby at least a portion of the convex surface of the second lens group is inserted into an aperture of the diaphragm blades, if the first lens frame and the second lens frame are separated by a second given distance or less.

2. The lens barrel according to claim 1, wherein
the lens barrel is retractable, and
the first lens frame and the second lens frame are separated by the second given distance or less when the lens barrel is in a retracted state.

3. The lens barrel according to claim 1, wherein
the lens barrel is retractable, and
the first lens frame and the second lens frame are separated by the second given distance or less, during the retracted state and during a telephoto edge state.

4. The lens barrel according to claim 1, wherein
the second lens group includes a mask diaphragm,
the adjustable diaphragm is pushed by the first lens frame and moves relatively toward the second lens frame, whereby the entire convex surface of the second lens group is inserted into the aperture of the diaphragm blades, when the first lens frame and the second lens frame are separated by a third given distance or less.

5. The lens barrel according to claim 4, wherein
the second given distance is shorter than the given distance, and
the third given distance is shorter than the second given distance.

6. The lens barrel according to claim 1, wherein
the first opening/closing mechanism is provided on the first lens frame and on the rotating member,
the second opening/closing mechanism is provided on the linear-guidance ring and on the rotating member.

7. The lens barrel according to claim 1, wherein
the first opening/closing mechanism is configured by a first tilt unit provided at a peripheral portion of the first lens frame and a first tilt receiving unit provided at a peripheral portion of the rotating member and capable of making contact with the first tilt unit, the rotating member being rotated by the first tilt receiving unit being guided toward the first tilt unit, if the first lens frame and the second lens frame are separated by the given distance or less,
the second opening/closing mechanism is configured by a second tilt unit provided on an inner surface of the linear-guidance ring and a second tilt receiving unit provided at a peripheral portion of the rotating member and capable of making contact with the second tilt unit, the rotating member rotating while moving in a direction parallel to the optical axis as a result of the second tilt receiving unit being guided toward the second tilt unit consequent to movement of the second lens frame, when the first lens frame and the second lens frame are separated by the given distance or more, and
a first angle formed by the first tilt unit (or the first tilt receiving unit) and the optical axis is greater than a second angle formed by the second tilt unit (or the second tilt receiving unit) and the optical axis.

8. The lens barrel according to claim 7, wherein
the second tilt unit and second tilt receiving unit move away from one another as the first tilt unit and the first tilt receiving unit contact and slide, when the first lens frame and the second lens frame are separated by the given distance or less.

9. A lens barrel comprising:
an adjustable diaphragm including
a rotating member that rotates about an optical axis, with respect to a base member;
an elastic member that biases the rotating member in a direction of a circumference centered about the optical axis, with respect to the base member, and
diaphragm blades that opens and closes consequent to rotation of the rotating member;
a lens frame that moves along a direction parallel to the optical axis, integrally with the adjustable diaphragm,
a linear-guidance ring that guides the lens frame in direction parallel to the optical axis; and
an opening/closing mechanism that controls the opening and closing of the diaphragm blades consequent to movement of the lens frame.

10. The lens barrel according to claim 9, wherein
the opening/closing mechanism is provided on the linear-guidance ring and the rotating member.

11. The lens barrel according to claim 9, wherein
the opening/closing mechanism is configured by a tilt unit that is provided on a inner surface of the linear-guidance ring and a tilt receiving unit that is provided at a peripheral portion of the rotating member and makes contact with the tilt unit, and controls the opening and closing of the diaphragm blades by the rotating member rotating about the optical axis while moving along the optical axis as a result of the tilt unit being guided to the tilt receiving unit consequent to movement of the lens frame in a direction parallel to the optical axis.

12. The lens barrel according to claim 9 further comprising
a first lens frame holding a first lens group, and together with the lens frame, sandwiching the adjustable diaphragm, along the optical axis, wherein
the lens frame holds a second lens group having at least a convex surface facing toward the first lens frame, and
the adjustable diaphragm is pushed by the first lens frame and moves relatively toward the lens frame and, at least a portion of the convex surface of the second lens group is inserted into an aperture of the diaphragm blades, if the first lens frame and the lens frame are separated by a given distance or less.
